(19) United States
(12) Patent Application Publication
(10) Pub. No.: US 2021/0302049 A1
(43) Pub. Date: Sep. 30, 2021

(54) SYSTEM, METHOD, AND COMPUTER PROGRAM PRODUCT FOR HUMAN THERMAL COMFORT-ORIENTED CONTROL OF MULTI SYSTEM HVAC DEVICES

(71) Applicant: Veev Group, Inc., San Mateo, CA (US)

(72) Inventors: Mati Matityahu AHARONYAN, Petakh Tikva (IL); Israel Jay KLEIN, Kfar Saba (IL)

(21) Appl. No.: 17/212,317

(22) Filed: Mar. 25, 2021

Related U.S. Application Data
(60) Provisional application No. 62/994,877, filed on Mar. 26, 2020.

(51) Int. Cl. F24F 11/63; G05B 15/02

(52) U.S. Cl. CPC F24F 11/63; G05B 15/02

(57) ABSTRACT

An HVAC system operative in conjunction with plural HVAC devices deployed at premises, the system comprising control logic operative to selectably maintain each of at least two climate control states and to selectably transition between said at least two states.

### REFERENCE TO CO-PENDING APPLICATIONS

Priority is claimed from U.S. Provisional Patent Application No. 62/994,877 entitled “Human thermal comfort-oriented control logic for multi system HVAC solutions” and filed 26 Mar. 2020, the disclosure of which application/s is hereby incorporated by reference.

### FIELD OF THIS DISCLOSURE

The present invention relates generally to heating, ventilation, and air conditioning (HVAC) systems, and more particularly to control thereof.

### BACKGROUND FOR THIS DISCLOSURE

Convection occurs when a moving fluid (gas) exchanges heat with its surroundings. Convection-based HVAC systems are systems which use convection for cooling or heating a room.

Typically, air from an interior environment, such as a room, is passed through a heat exchanger that was precooled or preheated by the mechanical system, is cooled or heated in the process, and is forced back to the room with a different temperature (and humidity). The movement of the air having a different temperature than the rest of the room makes heat transfer between the treated air and the rest of the room via a convection mechanism, thus cooling or heating the room and its occupants.

Radiant-based HVAC system are known. Surfaces in the interior of a building are cooled or heated, usually by being coupled to water or other fluid that was passed in a heat exchanger that was pre-cooled or heated by the mechanical system. When these surfaces are at a different temperature than the other surfaces in the room, they are able to exchange heat with the surroundings via electro-magnetic radiation, therefore changing the indoor conditions.

Both convection and radiant based systems will usually include a “Heat-Pump” unit which is the actual engine making the cooling\heating possible, and other system parts to bring or extract energy to or from a room, respectively. Therefore, the difference between the systems is mainly in the mechanism the systems use to transfer heat to or from the room.

Many HVAC installations are based on only a single system for providing cooling\heating. A good example is an air-to-air convection system, such as a wall mounted air-conditioner.

It is appreciated that most commonly, an “air conditioning” system consists of a heat-pump and its components, and a duct system for conveying air at a goal temperature and flow rate to an indoor space, e.g. as described above. Most of the control logic surrounding this system is about measuring the outlet air temperature (and relative humidity in some cases), and providing thermostatic regulation.

Modern HVAC solutions might incorporate plural systems for cooling\heating a single facility or home, such as a convection-based system, together with a radiant-based system.

Thermal comfort is a known term; the following describe state of the art research pertinent to this term:

Almesri al., I. e. (2012). An Air Distribution Index for Assessing the Thermal Comfort and Air Quality in Uniform and Nonuniform Thermal Environments. ASHRAE. (2004). The new ASHRAE standard 55. Bedford. (2013). Retrieved from www.researchgate.net/publication/258139973_An_Air_Distribution_Index_for_Assessing_the_Thermal_Comfort_and_Air_Quality_in_Uniform_and_Nonuniform_Thermal_Environments CIBSE. (2015). Environmental design guide. London: CIBSE. Fanger. (n.d.). Retrieved from www.researchgate.net/publication/289201295_A_review_of_thermal_comfort_and_method_of_using_Fanger's_PMV_equation/link/5807c7dfD8ae63c48fec77ef/download National Exposure Research Laboratory U. S. Environmental Protection Agency. (n.d.). The National Human Activity Pattern Survey (NHAPS). Wikipedia. (n.d.). Retrieved from en.wikipedia.org/wiki/ASHRAE_55

The disclosures of all publications and patent documents mentioned in the specification, and of the publications and patent documents cited therein directly or indirectly, are hereby incorporated by reference, other than subject matter disclaimers or disavowals. If the incorporated material is inconsistent with the express disclosure herein, the interpretation is that the express disclosure herein describes certain embodiments, whereas the incorporated material describes other embodiments. Definition/s within the incorporated material may be regarded as one possible definition for the term/s in question.

### SUMMARY OF CERTAIN EMBODIMENTS

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented, as appropriate.

No optimal guidelines are available for controlling an HVAC system comprised of plural subsystems. The importance becomes clear if using a convection system integrated with a radiant system (explained later), especially nowadays when the ability to measure radiant and non-radiant surface temperatures accurately is more approachable. Typically, such guidelines typically first map all the indoor thermal conditions possible for a specific project in a way that will divide or partition the possible indoor thermal conditions into a finite plural number of “states”. There will typically be similarities between projects, but no project is the same as a previous project, even in the aspect of the HVAC systems selected for each such project. When the control system is calibrated and running, the control system is typically able to control the HVAC equipment in a manner that will bring and maintain the indoor conditions to match the state that is desired at that moment in the quickest and most efficient manner, reducing energy consumption and mechanical wear, and not causing any discomfort or undesired situations for the occupants.

Embodiments thus include.

### Embodiment 1

An HVAC installation/solution including:

Plural HVAC devices/systems deployed at premises; and/or

Control logic operative to selectably maintain each of at least two states and/or to selectably transition between the at least two states, wherein each state may comprise a climate control scenario such as but not limited to all or any subset of: a “cooling” scenario, a “heating” scenario, a “null” scenario, and a “ventilation” scenario. In the null state, typically, the HVAC system is off or in a sleeping state or other state which is not fully on. In the ventilation state, there is no proactive heating or cooling system in place, or no energy conversion system (such as compressing/decompressing gas and utilizing the temperature differences) is active.

### Embodiment 2

An HVAC installation/solution according to any of the preceding embodiments wherein the plural HVAC devices/systems includes at least one radiant based device/system.

### Embodiment 3

An HVAC installation/solution according to any of the preceding embodiments and wherein a first algorithm is used to maintain each state, whereas another different state is used for transition between states.

It is appreciated that each algorithm may comprise a computer program measuring thermal related variable/s and may, e.g. accordingly, compute possible actions which relate to the climate control system. Switching between different algorithms means that either the “list” of variables which are measured are changed, and/or the computational formula and conditions, and/or actions (what the system can do and/or how much can the system do—for example, one algorithm may affect only air speed, and another only temperature settings. Another example—both algorithms can affect air speed, but the first one can only use settings 1-3, while the other one can only use settings 2-6).

### Embodiment 4

An HVAC installation/solution according to any of the preceding embodiments wherein the plural HVAC devices/systems include at least one convection based device/system.

### Embodiment 5

An HVAC installation/solution according to any of the preceding embodiments wherein the control logic receives a mean radiant temperature input and, accordingly, issues at least one command to at least one of the plural HVAC devices/systems.

### Embodiment 6

An HVAC installation/solution according to any of the preceding embodiments wherein at least one of the states is an all-systems-off state in which all of the plural HVAC devices/systems are switched off.

### Embodiment 7

An HVAC installation/solution according to any of the preceding embodiments wherein at least the two states are respectively applied at different times of day.

### Embodiment 8

An HVAC installation/solution according to any of the preceding embodiments wherein at least the two states are respectively applied at different times of year.

### Embodiment 9

An HVAC installation/solution according to any of the preceding embodiments wherein at least the two states are respectively applied for different states of occupancy of the premises (e.g. full-occupancy state vs. non-occupied state and/or vs. a partly occupied state).

### Embodiment 10

An HVAC installation/solution according to any of the preceding embodiments wherein at least one different state is pre-programmed.

### Embodiment 11

An HVAC installation/solution according to any of the preceding embodiments wherein at least one possible transition is pre-programmed.

### Embodiment 12

An HVAC installation/solution according to any of the preceding embodiments wherein at least one logic rule governing the control logic is pre-programmed.

### Embodiment 13

An HVAC installation/solution according to any of the preceding embodiments wherein at least one logic rule governing the control logic is learned.

### Embodiment 14

An HVAC installation/solution according to any of the preceding embodiments to which at least one measurement of mean radiant temperature (MRT) is provided using a device having a vacuum chamber made of IR transparent materials.

The terms convection-based system and radiant-based system are disjoint terms, as they incorporate different physics to transfer heat, but they can both comprise heat transfer systems between outdoors and indoor environments.

The systems' control might be separate and not integrated to optimize the operation.

A single system is a stand-alone system that can provide an HVAC solution by itself including the control. A house with three bedrooms, all being cooled by a split air-conditioner having a single “heat-pump”, constitutes a single system. A multiple system solution will integrate two or more separate solutions that would work properly to give one solution. For instance, in a house with an air conditioner being able to provide warm air, and additionally having electric floor heating, control of each entity will usually be separate, and hard to integrate, if decided upon.

Recent embodiments in the field of sensing and measurements provide an opportunity to integrate multi HVAC system controls. For instance, mean-radiant temperature (MRT), which is a weighted average surface temperature in an enclosed space, is a crucial index when measuring a radiant system performance status. If the radiant system is the only HVAC system, then the necessity is not great, because adaptations can be made. However, in a multi-system solution, the integrated operation requires more data to be implemented. For instance, incorporating a conventional AC system with a radiant cooling system will require some indices such as air temperature and speed, MRT, relative humidity etc. The more indices are measured, the more accurate is the control.

Therefore, when mean radiant temperature is measured correctly and radiant cooling\heating is a main system in the solution, the importance of good and precise system control may become crucial, especially when incorporated in a solution combined with other solutions, such as convection.

Problems may appear when using multi-system HVAC solutions. No optimal rules for sensor type, amount, and locations exist for making sure a control system has all the data it needs.

Additionally, no known optimal logic is found for organizing collected data from sensors in a room and using it for a planned HVAC system control in order to obtain or maintain human thermal comfort or other needs for an indoor environment.

It is appreciated that any reference herein to, or recitation of, an operation being performed is, e.g. if the operation is performed at least partly in software, intended to include both an embodiment where the operation is performed in its entirety by a server A, and also to include any type of “outsourcing” or “cloud” embodiments in which the operation, or portions thereof, is or are performed by a remote processor P (or several such), which may be deployed off-shore or “on a cloud”, and an output of the operation is then communicated to, e.g. over a suitable computer network, and used by, server A. Analogously, the remote processor P may not, itself, perform all of the operations, and, instead, the remote processor P itself may receive output/s of portion/s of the operation from yet another processor/s P′, may be deployed off-shore relative to P, or “on a cloud”, and so forth.

Also provided, excluding signals, is a computer program comprising computer program code means for performing any of the methods shown and described herein when the program is run on at least one computer; and a computer program product, comprising a typically non-transitory computer-usable or -readable medium e.g. non-transitory computer-usable or -readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes, or a general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with all or any subset of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as flash drives, optical disks, CDROMs, DVDs, BluRays, magnetic-optical discs or other discs; RAMs, ROMs, EPROMs, EEPROMs, magnetic or optical or other cards, for storing, and keyboard or mouse for accepting. Modules illustrated and described herein may include any one or combination or plurality of: a server, a data processor, a memory/computer storage, a communication interface (wireless (e.g. BLE) or wired (e.g. USB)), a computer program stored in memory/computer storage.

The term “process” as used above is intended to include any type of computation or manipulation or transformation of data represented as physical, e.g. electronic, phenomena which may occur or reside e.g. within registers and/or memories of at least one computer or processor. Use of nouns in singular form is not intended to be limiting; thus the term processor is intended to include a plurality of processing units which may be distributed or remote, the term server is intended to include plural typically interconnected modules running on plural respective servers, and so forth.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements all or any subset of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless stated otherwise, terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining”, “providing”, “accessing”, “setting” or the like, refer to the action and/or processes of at least one computer/s or computing system/s, or processor/s or similar electronic computing device/s or circuitry, that manipulate and/or transform data which may be represented as physical, such as electronic, quantities e.g. within the computing system's registers and/or memories, and/or may be provided on-the-fly, into other data which may be similarly represented as physical quantities within the computing system's memories, registers or other such information storage, transmission or display devices or may be provided to external factors e.g. via a suitable data network. The term “computer” should be broadly construed to cover any kind of electronic device with data processing capabilities, including, by way of non-limiting example, personal computers, servers, embedded cores, computing system, communication devices, processors (e.g. digital signal processor (DSP), microcontrollers, field programmable gate array (FPGA), application specific integrated circuit (ASIC), etc.) and other electronic computing devices. Any reference to a computer, controller or processor is intended to include one or more hardware devices e.g. chips, which may be co-located or remote from one another. Any controller or processor may, for example, comprise at least one CPU, DSP, FPGA or ASIC, suitably configured in accordance with the logic and functionalities described herein.

Any feature or logic or functionality described herein may be implemented by processor/s or controller/s configured as per the described feature or logic or functionality, even if the processor/s or controller/s are not specifically illustrated for simplicity. The controller or processor may be implemented in hardware, e.g., using one or more Application-Specific Integrated Circuits (ASICs) or Field-Programmable Gate Arrays (FPGAs) or may comprise a microprocessor that runs suitable software, or a combination of hardware and software elements.

The present invention may be described, merely for clarity, in terms of terminology specific to, or references to, particular programming languages, operating systems, browsers, system versions, individual products, protocols and the like. It will be appreciated that this terminology or such reference/s is intended to convey general principles of operation clearly and briefly, by way of example, and is not intended to limit the scope of the invention solely to a particular programming language, operating system, browser, system version, or individual product or protocol. Nonetheless, the disclosure of the standard or other professional literature defining the programming language, operating system, browser, system version, or individual product or protocol in question, is incorporated by reference herein in its entirety.

Elements separately listed herein need not be distinct components and alternatively may be the same structure. A statement that an element or feature may exist is intended to include (a) embodiments in which the element or feature exists; (b) embodiments in which the element or feature does not exist; and (c) embodiments in which the element or feature exist selectably e.g. a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate or route, or otherwise manipulate or process information as described herein and/or to perform functionalities described herein and/or to implement any engine, interface or other system illustrated or described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

The system shown and described herein may include a user interface/s e.g. as described herein which may for example include all or any subset of: an interactive voice response interface, automated response tool, speech-to-text transcription system, automated digital or electronic interface having interactive visual components, web portal, visual interface loaded as web page/s or screen/s from server/s via communication network/s to a web browser or other application downloaded onto a user's device, automated speech-to-text conversion tool, including a front-end interface portion thereof and back-end logic interacting therewith. Thus the term user interface or “UI” as used herein, includes also the underlying logic which controls the data presented to the user e.g. by the system display and receives and processes and/or provides to other modules herein, data entered by a user e.g. using her or his workstation/device.

### BRIEF DESCRIPTION OF THE DRAWINGS

Example embodiments are illustrated in the various drawings. Specifically:

Certain embodiments of the present invention are illustrated in the following drawings:

FIGS. 1, 2, 4a-4b and 5 are tables useful in understanding certain embodiments of the invention; all or any subset of the rows, columns and cells within each table may be provided; and

FIG. 3 is a simplified diagram useful in understanding certain embodiments of the invention.

In the block diagrams, arrows between modules may be implemented as APIs and any suitable technology may be used for interconnecting functional components or modules illustrated herein in a suitable sequence or order e.g. via a suitable API/Interface. For example, state of the art tools may be employed, such as but not limited to Apache Thrift and Avro which provide remote call support. Or, a standard communication protocol may be employed, such as but not limited to HTTP or MQTT, and may be combined with a standard data format, such as but not limited to JSON or XML.

Methods and systems included in the scope of the present invention may include any subset or all of the functional blocks shown in the specifically illustrated implementations by way of example, in any suitable order e.g. as shown. Flows may include all or any subset of the illustrated operations, suitably ordered e.g. as shown. Tables herein may include all or any subset of the fields and/or records and/or cells and/or rows and/or columns described.

Computational, functional or logical components described and illustrated herein can be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs, and may originate from several computer files which typically operate synergistically.

Each functionality or method herein may be implemented in software (e.g. for execution on suitable processing hardware such as a microprocessor or digital signal processor), firmware, hardware (using any conventional hardware technology such as Integrated Circuit Technology) or any combination thereof.

Functionality or operations stipulated as being software-implemented may alternatively be wholly or fully implemented by an equivalent hardware or firmware module, and vice-versa. Firmware implementing functionality described herein, if provided, may be held in any suitable memory device and a suitable processing unit (aka processor) may be configured for executing firmware code. Alternatively, certain embodiments described herein may be implemented partly or exclusively in hardware in which case all or any subset of the variables, parameters, and computations described herein may be in hardware.

Any module or functionality described herein may comprise a suitably configured hardware component or circuitry. Alternatively or in addition, modules or functionality described herein may be performed by a general purpose computer, or more generally, by a suitable microprocessor, configured in accordance with methods shown and described herein, or any suitable subset, in any suitable order, of the operations included in such methods, or in accordance with methods known in the art.

Any logical functionality described herein may be implemented as a real time application, if and as appropriate, and which may employ any suitable architectural option, such as but not limited to FPGA, ASIC or DSP, or any suitable combination thereof.

Any hardware component mentioned herein may in fact include either one or more hardware devices e.g. chips, which may be co-located or remote from one another.

Any method described herein is intended to include within the scope of the embodiments of the present invention also any software or computer program performing all or any subset of the method's operations, including a mobile application, platform or operating system e.g. as stored in a medium, as well as combining the computer program with a hardware device to perform all or any subset of the operations of the method.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include any apparatus which is primary, secondary, tertiary or off-line, which is of any type or level or amount or category of volatility, differentiation, mutability, accessibility, addressability, capacity, performance and energy use, and which is based on any suitable technologies such as semiconductor, magnetic, optical, paper and others.

### DETAILED DESCRIPTION OF CERTAIN EMBODIMENTS

Typically, certain embodiments of the invention provide climate control system for installations which include various heating and cooling components, typically at least one of which is radiant based. Measurements taken typically include mean-radiant temperature. Control logic (an algorithm) is provided to preserve a state, and other control logic is provided, which, when applied, yields to a transition between two states. The various states and/or possible transmissions and/or logic rules may be pre-programmed.

Certain embodiments of the invention may combine a radiant-based cooling or heating system control along with other systems, especially with a convection based one.

Radiant based systems' influence on surroundings may be observed by measuring the mean radiant temperature rather than the air temperature.

Certain embodiments of the invention distinguish plural “cooling” or “heating” scenarios or states. At times the invention may maintain or preserve a state, and at other times the invention may transition between a current state to a new state. Typically, a first “algorithm” is used to maintain a certain state, and another “algorithm” is applied for the transition state (until the invention reaches the new state).

### Example

state A is non-occupied house, during summer. This may mean that no systems are turned on, and this state is maintained, until a “trigger event” occurs, which indicates that the system is to prepare the house for tenants about to return home. The system of the proposed invention will now shift to state B (“evening time”, “full-occupancy”, “summer”). During the shift from state A to state B, certain logic is applied (for example, full power convection activation, no radiant activation). When eventually state B is achieved, the above “logic” is replaced with other logic (for example, low power convection, max radiant cooling) having a purpose e.g. the main purpose of maintaining state B.

In at least one e.g. all control scenarios there may be use of measuring parameter/s including mean radiant temperature, and, responsively, affecting the surroundings of the house by applying certain appropriate controls.

It is sometimes desirable to combine convection with radiation.

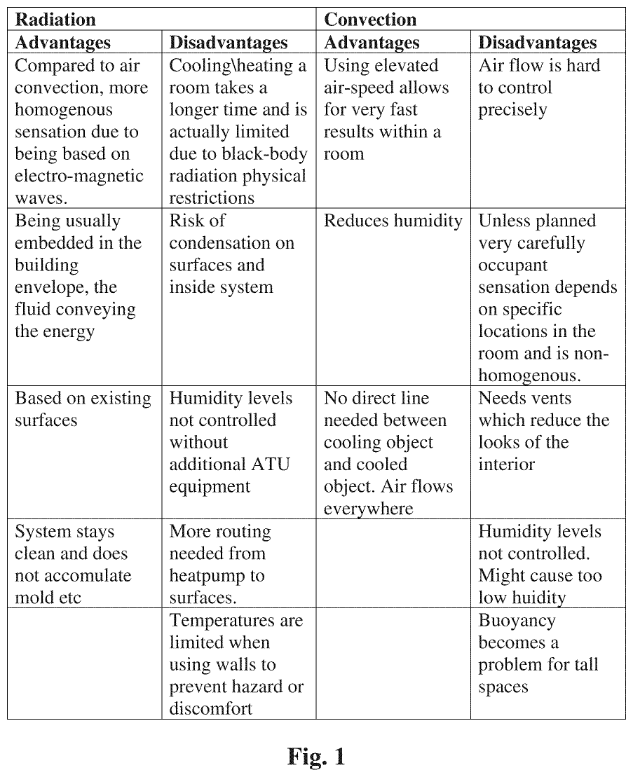

Different advantages in radiation vs. convection are shown in FIG. 1.

Energy consumption might be reduced if both solutions are incorporated, along with more easily achievable comfort and performance.

It is easier to achieve human thermal comfort because a convection system will have a high impact on fluid convection heat transfer, and a radiant system will have a high impact on IR radiative heat transfer.

Typically, there is a possibility to achieve different zones for different cooling\heating states within one room, a fortiori to achieve different states in different rooms.

FIG. 1, aka Table A, illustrates a comparison of radiation Vs. convection embodiments, presenting the advantages and disadvantages of each.

### Using an HVAC Solution Comprising Plural Systems

Due to the different advantages of radiation compared to convection, the use of a combined system solution can be very useful if implemented correctly e.g. as described herein. Each part of an HVAC system can have a different influence on the indices affecting occupant comfort e.g. as shown in FIG. 2, aka Table b. In FIG. 2, an asterisk is used to denote a negligible influence, and a double asterisk is used to denote a possible influence on homogeneity.

### Sensing and Obtaining Data

Following knowledge accumulated in the last centuries, it is well known today that the thermal sensation of an occupant in an indoor space is dependent on several factors. Among them are factors which are dependent on the room's conditions around the occupant e.g. all or any subset of:

Air temperature: The temperature of the air around an occupant.

Air velocity: The velocity of the air around an occupant, which may be directional.

Relative humidity: The relative humidity around an occupant. Relative humidity is the percentage ratio of the water vapor pressure in the air to the water saturation vapor pressure in the air. It is temperature highly dependent.

Mean radiant temperature (MRT): intended to include a weighted average of the temperatures of the surfaces around the occupant.

In radiant based HVAC systems this factor has been shown to have a non-negligible impact on the performance and comfort of occupants. When an occupant is in a room cooled or heated by radiating surfaces, their temperature influences the comfort sensation greatly. Having a typically simple device being able to measure the MRT and incorporate its value in the overall thermal comfort evaluation is an approach towards better controlling complicated HVAC systems. It is possible to obtain a measurement of mean radiant temperature (MRT) using a device such as a globe thermometer or using thermal cameras. Indirect derivation is also possible such as measuring temperatures somewhere in the system (pipes) and learning what would be the corresponding MRT. Modern, more direct measuring techniques incorporate thermal cameras and other more advanced devices.

Clothing; and/or metabolism are occupant dependent indices influencing the thermal comfort of an occupant which may (either or both) be obtained. The two are not system dependent and cannot be controlled, but either or both of them may be monitored and may influence the control. There are different standards today, showing the relationships between the indices and their impact on thermal comfort or the building's thermal envelope.

### Index Independence

It is typically inaccurate to assume that the monitored indices are independent of each other, or unrelated to each other. There are many relationships between the different indices measured in an indoor environment (such as MRT, air temperature, humidity etc.), which might influence each other when changed. Such examples may include:

An increase in air temperature might decrease the relative humidity due to elevated water saturation vapor pressure.
Elevated air velocity will contribute to the heat transfer to and from the air. This may cause change in air temperature, surface temperatures, and even relative humidity.
A large change in radiant temperature will change the air temperature accordingly, and vice versa. Air moves close to surfaces and energy is transferred between them.

The above is not to be confused with the indices' influence on the overall conditions in the room; the indices may also influence each other, which may be an important consideration for system planners.

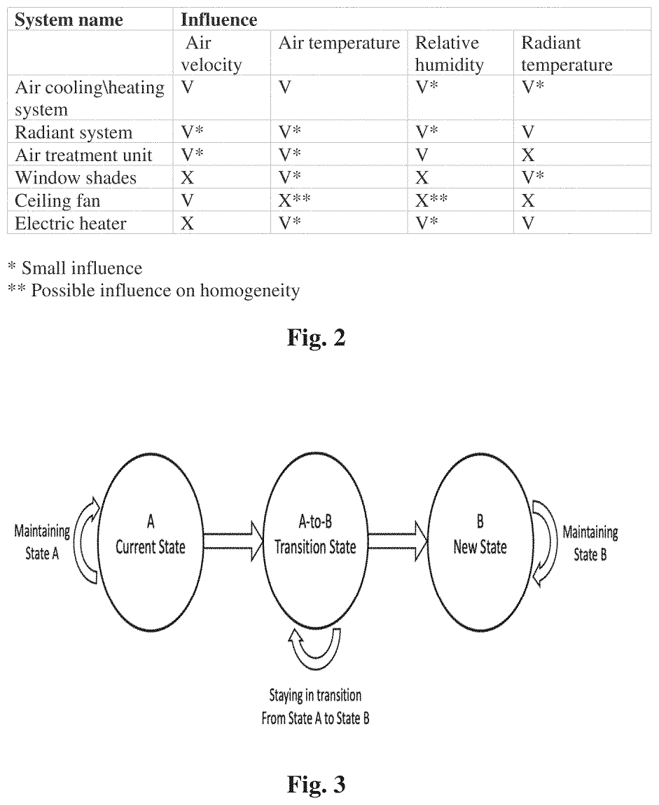

The solution may include the following basic logic.
Typically, an optimized system will change a room's climate quickly, efficiently and correctly from any state to a “goal state” and will, typically, maintain the state. It will typically use data about the indices discussed before from the sensors located in the room, and act accordingly e.g. as shown pictorially in FIG. 3.
State definition: Typically, there is an uncertainty about which state can be defined as a “goal state”. A state typically includes a group or set of thermal indices' values. When measured, it is possible to determine the state in which the system is at currently, however the goalstate must be determined as a “blob” having boundaries for its index values because:
a. There will always be an error in every measuring device used for the monitoring. The accumulated error might not be negligible.
b. Every measuring device has a “dead-zone” in which it is not reliable and the errors can be greater.
c. The mechanical systems provide a change in the discussed indices. No mechanical system can control a room's climate with no fluctuations. Additionally, some systems work in intervals, causing gaps in performance.
d. Sometimes, more environmental and occupant dependent factors might impact a measurement or a state for a long or short time. For instance, if someone has decided to start cooking in the kitchen this will cause a temporary rise in the relative humidity, but not actually change the state.
e. Delays in time between sensing and implementation increase uncertainty. HVAC systems cannot change a state in a room immediately.
   These reasons and others create an uncertainty in the ability to pin a “goal state” and order the mechanical system to try and reach it. Therefore, a goal state will be considered as a “blob” in the index space, having minimal and maximal boundaries, allowing a more flexibility and obtainable definitions of a goal state. So, for instance a goal air temperature will not be 24° C., but rather between 21° C. and 26° C. in order to be practical and achievable.

### Goal State Determination

There are typically, many possible ways for a logic system e.g. a processor to determine a goal state at any given moment.

### Example

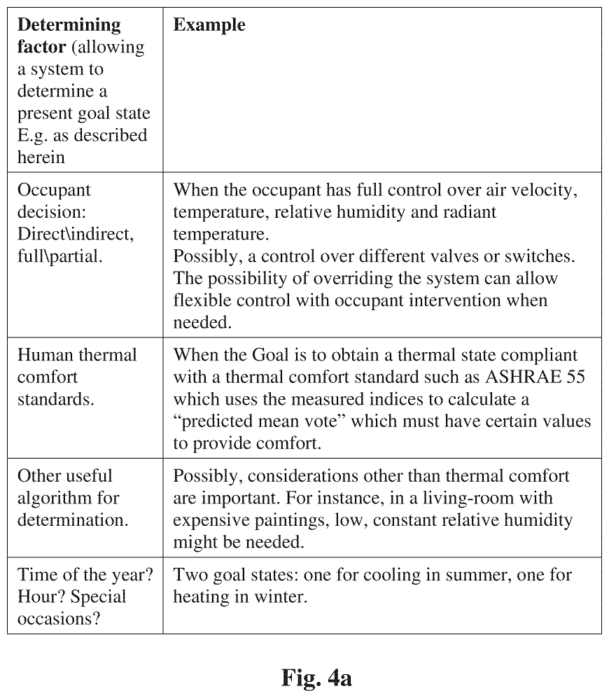

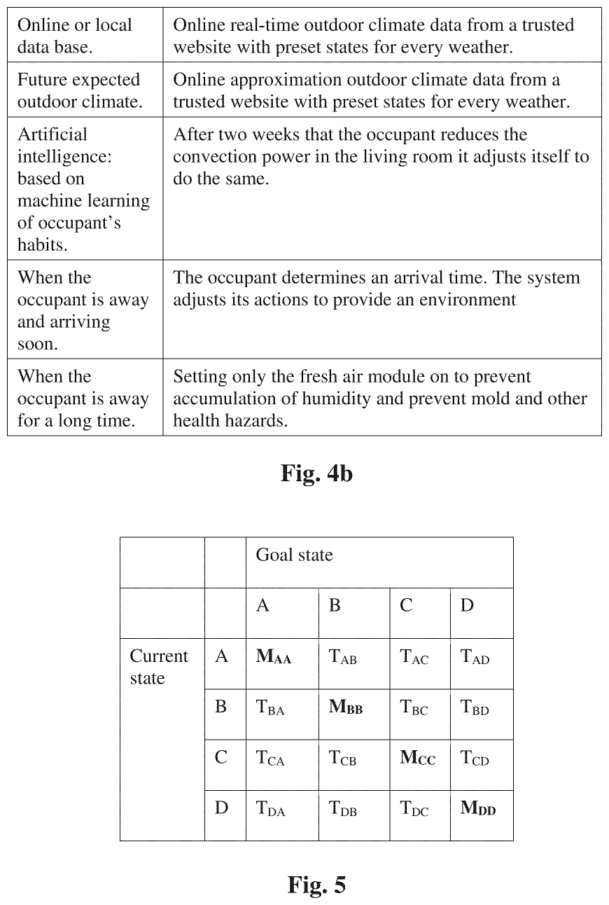

Assuming the system is programmed to work according to thermal comfort standards when unchanged by the occupant (this is one of the possibilities in the table of FIGS. 4a-4b, taken together). Then, only some of the possible combinations for room conditions will be desired. This is called a state. For instance, air temperature between 20 to 24° C., MRT between 17 to 19° C. and RH (relative humidity) of between 40% to 60%. If the measured indices do not comply, and are not in the indices' limits, the system operation will be changed to reach it. If all conditions are within limits, besides the MRT which is too high, the radiant system's water temperature will be decreased to 8° C. This constitutes a transition phase, until the desired conditions are reached. The other systems' operation might not be changed in this phase, meaning that changes in operation might take place only in a single system. If conditions in the room are within these limits, the operation will be set to maintain this state. The actual state will be within the boundaries of the goal state already reached. For instance, air temperature at outlet is set to 19° C., radiant system's temperature is set to 12° C. and the dehumidifier is turned on for a minute, every 5 minutes.

FIGS. 4a-4b, aka table D, summarizes the different possibilities; the factors for possible control determination logic shown in the table of FIGS. 4a-4b, taken together, are merely exemplary.
It is appreciated that the occupant's personal desire might be very relevant. Typically, in certain embodiments this algorithm sets general rules for obtaining a desired goal state in which an occupant's preference is only one possibility to determine a “goal state”. Another option, for instance, might be conditions determined by thermal comfort standards known world-wide (also in the table of FIGS. 4a-4b, taken together, aka Table D).

### Obtaining and Maintaining a Goal State

The logic behind the control of the (or each) HVAC system typically, will have a predetermined table (e.g. the table of FIGS. 4a-4b, taken together, aka table E) in which there are two possibilities for control of the system, each of them comprised of a “state” and a mechanical operation for the system:
If the current state is different than the goal-state, the system will work to move from the current state to the goal state in the most optimal way. For example, if the room air temperature measured is 25° C. with a relative humidity of 60%, and the goal state is at a temperature between 19-21° C. with a relative humidity of 35-45%, the dehumidifier will be turned on to maximum power, the convection system will be turned on in full power, and the radiant surfaces' temperature will be set to 15° C.
If the current state is in the region of the goal-state, the system will work to maintain the state until the goal state is changed. For example, if the goal state determines that the operative temperature (a weight average of the air and the surfaces) needs to be between 20-22° C., and the current state is actually between these boundaries, the convection system will stop, and the radiant surfaces' temperature will be maintained at 12° C.
A goal or current state can be defined as a combination of the various measurements being in their limits. For instance, air temperature between 20 to 22° C., MRT between 17 to 19, and relative humidity (RH) between 40% to 45%. These limits will define the “region” termed a current\goal state. If the actual state measured is not between these boundaries, the mechanical operation may be defined to help reach the limits.
   typically, there is a comparison to lower and upper limits that were predetermined and a determination may be made, of whether the current state is acceptable or not. If acceptable e.g. between limits, the system may try to maintain the state. If not acceptable, the system may take action to achieve a value between the limits.

In the table of FIG. 5 each cell typically represents certain rules for an HVAC system control. It is appreciated that FIG. 5 is but one possible schematic for maintaining or transitioning to a goal state, and is not intended to be limiting.

Rules can be very flexible and determined by the person implementing the method, for instance a company producing control equipment. Every cell will contain the current state of the indoor indices, the relevant goal state, and the mechanical operation to maintain or transit to the goal state.

Take an example of a transition state, T_DA. Let state A, the goal state, be a state in which the room is at its coldest setpoint: Air temperature of 16-17° C. MRT of 10-11 C and RH of 30%-40%. Let state D which is the current state be somewhere else in this “Space” where the air temperature is higher than the limit—20-24° C., MRT is 10-11 C and RH is 30%-40%. The transition state will have the details for controlling the mechanical HVAC system. In this situation, where only the air temperature is too high, the air conditioner part of the system will be set to provide better performance, for instance: air velocity from 2 to 3 (arbitrary units), goal outlet temperature from 20 C to 16° C.

Typically, the diagonal line represents situations in which the current state and the goal state are the same, and the system is set for maintaining the state. The other cells represent situations in which the goal state is to be achieved. For instance, T_{CA} is when the current state is some state “C” and the goal state is some state “A” and the system is in transition from “C” to “A”.

Certain embodiments operative for reaching and/or maintaining a state may be characterized by all or any subset of the following:

Maintaining a state can be done iteratively.

Monitoring intervals may be determined. A monitoring interval may include: obtaining sensor data and metadata if needed and available, comparing a state to a goal or current state, and making a decision whether a change is needed in the HVAC system's operation. The monitoring intervals cannot be determined a priori due to the variety of implementation possibilities. The goal may be system control which has the correct data at any time and can maintain or change a mechanical system's operation correctly with no unnecessary delay. Ideally, the intervals should be as short as possible.

Knowledge regarding HVAC operation and capabilities may be used when planning how to reach the state. For instance, transitions can be mainly based on the convection system, if possible. Its heat transfer rate will be faster than with radiation.

Gradually decreasing the system power when approaching the goal state will decrease the chance of passing the goal state, and will help to reach the goal state faster.

When entering a thermo-regulated indoor environment, positive Alliesthesia (the sensation of a positive change) is usually felt by the occupant. For such occasions, over-heating\cooling might be correct and positive for the occupant aka end-user and energy consumption.

Certain routes to the goal state may be limited in order not to reach undesired situations such as HVAC system damage, human discomfort, indoor environment etc. For instance, an elevated air speed for increasing power might cause discomfort, and is typically avoided.

Maintaining a state can be done by determining the necessary HVAC behavior.

For example (e.g. with reference to the table of FIG. 5), every implemented system may have a logic table similar to this (not necessarily with the same dimensions. The dimensions may be equal to the number of possible states) with instructions for the system to operate. The diagonal line of the table describes the first option: maintaining a state, for instance M_AA, means that the system is in state A, and needs to be maintained as such. Respectively, the system will have operating instructions for maintaining this state. Example: Let state A be a state in which the room is at an air temperature of 16-17° C., MRT of 10-11 C and RH of 30%-40%. Assuming for now (and this is why calibration is needed), that in order to stay in this state the mechanical operation needed is known, then the system will have the information for the correct operation, for example: to maintain state A, keep the air conditioning unit with medium air speed at air temperature 16° C. in the outlet, and water temperature in the radiant system at 8° C. Correct calibration using a technician or machine learning from the data obtained during multiple operations will be needed.

Monitoring intervals should typically be determined to make sure the state is maintained.

Operation may be based on the radiant system if possible. The radiant mechanism will provide more long-term comfort and enables fine-tuning, more than convection.

Small changes in the system performance will make sure not to exceed heating or cooling requirements of the state.

### System Calibration

The system may be calibrated, either manually or automatically. Table E of FIG. 5 may be completed during this calibration process. For every project, if an optimal, thermal comfort oriented, energy efficient oriented, or any other approach is needed, calibration may be needed because all projects are dissimilar, and may require different details. To implement a control system which obtains data and matches it to an HVAC system's operation in a way that will help achieve the desired conditions easily, quickly and efficiently, the logic must be, insofar as possible, compatible to the system and building in which it is installed.
A good calibration may be achieved manually after an installation. For instance, understanding the needs of the occupants and the properties of the building, and choosing optional states for different seasons. Then the system may be turned on and mechanical operations may be defined and tested to facilitate the desired transitions or maintenance of states. This may not be a single calibration, and, instead, may be done until the system function is perfect.
Another option is to let the system use the data obtained during the operation to find the best possible mechanical setup for maintaining or obtaining every state.
For instance, when certain states cause discomfort, these situations must be avoided, or when certain states are undesired by the occupant.

Certain states may cause mechanical problems, such as using a very high fan RPM, which may damage it.

Additionally, certain states may cause indoor environment problems, such as condensation.

Testing system performance for passing and maintaining states may be recommended for some use-cases.

Events which Might Change States Unexpectedly
Possibly, the goal state or current state might change unexpectedly, or at short notice. This may happen for many different reasons and is typically addressed. Such reasons include opening a window or a shade, opening a door, occupant activity, high occupancy, cooking or taking a shower (impact on humidity), high power appliances, different clothing than expected is being worn, or a mechanical problem in the HVAC system.

A good control system may be programmed to deal with such events. The table of FIG. 5 (say) may be completed when all data for the project is available, such as: building structure and address, use, HVAC system etc. Once the above-referenced calibration process has been suitably completed, the table content determination can stay constant. An update may be made if changes are made such as change in one or more of HVAC components, change of occupancy, change in building, or its immediate surroundings. Every time the system is calibrated, the table may stay unchanged until the next time calibration is done. Over a long period of calibration, such as with artificial intelligence or occupant input, the table might be updated, until the desired outcome is reached. The table is typically stored locally to enable control, even in situations of interrupted Internet communication. If implementation is done by a company, the option of storing the table on a server might be relevant, for remote control or setup, or for obtaining data for future use or reference.

Control algorithms and/or rules/tables may be implemented in software.

The invention includes, but is not limited to, circuitry, comprising at least one hardware processor and at least one memory and is configured to perform at least one of or any combination of the described operations or to execute any combination of the described modules.

It is appreciated that terminology such as “mandatory”, “required”, “need” and “must” refer to implementation choices made within the context of a particular implementation or application described herewithin for clarity, and are not intended to be limiting, since, in an alternative implementation, the same elements might be defined as not mandatory and not required, or might even be eliminated altogether.

Components described herein as software may, alternatively, be implemented wholly or partly in hardware and/or firmware, if desired, using conventional techniques, and vice-versa. Each module or component or processor may be centralized in a single physical location or physical device, or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order, including simultaneous performance of suitable groups of operations as appropriate. Included in the scope of the present disclosure, inter alia, are machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order i.e. not necessarily as shown, including performing various operations in parallel or concurrently rather than sequentially as shown; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform e.g. in software any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such, at least one processor configured to perform any combination of the described operations or to execute any combination of the described modules; and hardware which performs any or all of the operations of any of the methods shown and described herein, in any suitable order, either alone, or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g. by one or more processors. The invention shown and described herein may include (a) using a computerized method to identify a solution to any of the problems or for any of the objectives described herein, the solution optionally including at least one of a decision, an action, a product, a service or any other information described herein that impacts, in a positive manner, a problem or objectives described herein; and (b) outputting the solution.

The system may, if desired, be implemented as a network—e.g. web-based system employing software, computers, routers and telecommunications equipment as appropriate.

Any suitable deployment may be employed to provide functionalities e.g. software functionalities shown and described herein. For example, a server may store certain applications, for download to clients, which are executed at the client side, the server side serving only as a storehouse. Any or all functionalities e.g. software functionalities shown and described herein, may be deployed in a cloud environment. Clients e.g. mobile communication devices such as smartphones, may be operatively associated with, but external to the cloud.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Any “if-then” logic described herein is intended to include embodiments in which a processor is programmed to repeatedly determine whether condition x, which is sometimes true and sometimes false, is currently true or false, and to perform y each time x is determined to be true, thereby to yield a processor which performs y at least once, typically on an “if and only if” basis e.g. triggered only by determinations that x is true and never by determinations that x is false.

Any determination of a state or condition described herein, and/or other data generated herein, may be harnessed for any suitable technical effect. For example, the determination may be transmitted or fed to any suitable hardware, firmware or software module, which is known or which is described herein to have capabilities to perform a technical operation responsive to the state or condition. The technical operation may, for example, comprise changing the state or condition, or may more generally cause any outcome which is technically advantageous given the state or condition or data, and/or may prevent at least one outcome which is disadvantageous given the state or condition or data. Alternatively or in addition, an alert may be provided to an appropriate human operator or to an appropriate external system.

Features of the present invention, including operations, which are described in the context of separate embodiments, may also be provided in combination in a single embodiment. For example, a system embodiment is intended to include a corresponding process embodiment, and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art and particularly, although not limited to, those described in the Background section, or in publications mentioned therein.

Conversely, features of the invention, including operations, which are described for brevity in the context of a single embodiment or in a certain order, may be provided separately, or in any suitable sub-combination, including with features known in the art (particularly, although not limited to, those described in the Background section, or in publications mentioned therein) or in a different order. “e.g.” is used herein in the sense of a specific example which is not intended to be limiting. Each method may comprise all or any subset of the operations illustrated or described, suitably ordered e.g. as illustrated or described herein.

Devices, apparatus or systems shown coupled in any of the drawings may in fact be integrated into a single platform in certain embodiments, or may be coupled via any appropriate wired or wireless coupling, such as but not limited to optical fiber, Ethernet, Wireless LAN, HomePNA, power line communication, cell phone, Smart Phone (e.g. iPhone), Tablet, Laptop, PDA, Blackberry GPRS, Satellite including GPS, or other mobile delivery. It is appreciated that in the description and drawings shown and described herein, functionalities described or illustrated as systems and sub-units thereof can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation, and is not intended to be limiting.

Any suitable communication may be employed between separate units herein e.g. wired data communication and/or in short-range radio communication with sensors such as cameras e.g. via WiFi, Bluetooth or Zigbee.

It is appreciated that implementation via a cellular app as described herein is but an example, and, instead, embodiments of the present invention may be implemented, say, as a smartphone SDK, as a hardware component, as an STK application, or as suitable combinations of any of the above.

Any processing functionality illustrated (or described herein) may be executed by any device having a processor, such as but not limited to a mobile telephone, set-top-box, TV, remote desktop computer, game console, tablet, mobile e.g. laptop or other computer terminal, embedded remote unit, which may either be networked itself (may itself be a node in a conventional communication network e.g.) or may be conventionally tethered to a networked device (to a device which is a node in a conventional communication network or is tethered directly or indirectly/ultimately to such a node).

Any operation or characteristic described herein may be performed by another actor outside the scope of the patent application, and the description is intended to include any apparatus, whether hardware, firmware or software which is configured to perform, enable or facilitate that operation or to enable, facilitate, or provide that characteristic.

The terms processor or controller or module or logic as used herein are intended to include hardware such as computer microprocessors or hardware processors, which typically have digital memory and processing capacity, such as those available from, say Intel and Advanced Micro Devices (AMD). Any operation or functionality or computation or logic described herein may be implemented entirely or in any part, on any suitable circuitry, including any such computer microprocessor/s as well as in firmware or in hardware or any combination thereof.

It is appreciated that elements illustrated in more than one drawing, and/or elements in the written description may still be combined into a single embodiment, unless otherwise specifically clarified herewithin. Any of the systems shown and described herein may be used to implement or may be combined with, any of the operations or methods shown and described herein.

It is appreciated that any features, properties, logic, modules, blocks, operations or functionalities described herein which are, for clarity, described in the context of separate embodiments, may also be provided in combination in a single embodiment, except where the specification or general knowledge specifically indicates that certain teachings are mutually contradictory and cannot be combined. Any of the systems shown and described herein may be used to implement, or may be combined with, any of the operations or methods shown and described herein.

Conversely, any modules, blocks, operations or functionalities described herein, which are, for brevity, described in the context of a single embodiment, may also be provided separately, or in any suitable sub-combination, including with features known in the art. Each element e.g. operation described herein, may have all characteristics and attributes described or illustrated herein, or, according to other embodiments, may have any subset of the characteristics or attributes described herein.

1. An HVAC system operative in conjunction with plural HVAC devices deployed at premises, the system comprising:
control logic operative to selectably maintain each of at least two climate control states and to selectably transition between said at least two states.

2. The system of claim 1 and also comprising plural HVAC devices deployed at premises.

3. The system according to claim 1 and wherein a first dedicated algorithm is configured to maintain each of said states, whereas a second dedicated algorithm which differs from said first dedicated algorithm is configured for transitioning between said states.

4. The system according to claim 1 wherein the plural HVAC devices/systems includes at least one convection based device/system.

5. The system according to claim 1 wherein said control logic receives a mean radiant temperature input and, accordingly, issues at least one command to at least one of said plural HVAC devices/systems.

6. The system according to claim 1 wherein at least one of said states is an all-systems-off state in which all of said plural HVAC devices/systems are switched off.

7. The system according to claim 1 wherein at least said two states are respectively applied at different times of day.

8. The system according to claim 1 wherein at least said two states are respectively applied at different times of year.

9. The system according to claim 1 wherein at least said two states are respectively applied for different states of occupancy of the premises (e.g. full-occupancy state vs. non-occupancy state and/or vs. a partly occupied state).

10. The system according to claim 1 wherein at least one different state is pre-programmed.

11. The system according to claim 1 wherein at least one possible transition is pre-programmed.

12. The system according to claim 1 wherein at least one logic rule governing said control logic is pre-programmed.

13. The system according to claim 1 wherein at least one logic rule governing said control logic is learned.

14. The system according to claim 5 wherein at least one measurement of said mean radiant temperature (MRT) is provided using a device having a vacuum chamber made of IR transparent materials.

15. The system according to claim 1 wherein the plural HVAC devices/systems includes at least one radiant based device/system.

16. An HVAC control method operative in conjunction with plural HVAC devices deployed at premises, the method comprising:
using control logic to selectably maintain each of at least two climate control states and to selectably transition between said at least two states.

17. A computer program product, comprising a non-transitory tangible computer readable medium having computer readable program code embodied therein, said computer readable program code adapted to be executed to implement an HVAC control method operative in conjunction with plural HVAC devices deployed at premises, the method comprising:
using control logic to selectably maintain each of at least two climate control states and to selectably transition between said at least two states.

18. The system according to claim 1 wherein, said climate control states include at least one of: a cooling scenario, a heating scenario, a null scenario and a ventilation scenario.

19. The system according to claim 5 wherein at least one measurement of said mean radiant temperature (MRT) is derived from other measurements including at least one of surface temperature, air temperature, air velocity.
